(19) United States
(12) Patent Application Publication
(10) Pub. No.: US 2020/0350138 A1
(43) Pub. Date: Nov. 5, 2020

(54) HIGH BRIGHTNESS X-RAY REFLECTION SOURCE

(71) Applicant: Sigray, Inc., Concord, CA (US)

(72) Inventors: Wenbing Yun, Walnut Creek, CA (US); Sylvia Jia Yun Lewis, San Francisco, CA (US); Janos Kirz, Berkeley, CA (US); William Henry Hansen, Genola, UT (US)

(21) Appl. No.: 16/866,953

(22) Filed: May 5, 2020

Related U.S. Application Data
(63) Continuation of application No. 16/518,713, filed on Jul. 22, 2019, now Pat. No. 10,658,145.
(60) Provisional application No. 62/703,836, filed on Jul. 26, 2018.

(51) Int. Cl. H01J 35/12; H01J 35/30; H01J 35/14

(52) U.S. Cl. CPC H01J 35/12; H01J 35/30; H01J 35/153; H01J 2235/081; H01J 2235/088; H01J 2235/1204; H01J 35/147

(57) ABSTRACT

An x-ray target, x-ray source, and x-ray system are provided. The x-ray target includes a thermally conductive substrate comprising a surface and at least one structure on or embedded in at least a portion of the surface. The at least one structure includes a thermally conductive first material in thermal communication with the substrate. The first material has a length along a first direction parallel to the portion of the surface in a range greater than 1 millimeter and a width along a second direction parallel to the portion of the surface and perpendicular to the first direction. The width is in a range of 0.2 millimeter to 3 millimeters. The at least one structure further includes at least one layer over the first material. The at least one layer includes at least one second material different from the first material. The at least one layer has a thickness in a range of 2 microns to 50 microns. The at least one second material is configured to generate x-rays upon irradiation by electrons.

### CLAIM OF PRIORITY

The present application is a continuation from U.S. patent application Ser. No. 16/518,713 filed Jul. 22, 2019 which claims the benefit of priority to U.S. Provisional Appl. No. 62/703,836, filed Jul. 26, 2018 which is incorporated in its entirety by reference herein.

### BACKGROUND

### Field

This application relates generally to x-ray sources.

### Description of the Related Art

Laboratory x-ray sources generally bombard a metal target with electrons, with the deceleration of these electrons producing Bremsstrahlung x-rays of all energies from zero to the kinetic energy of the electrons. In addition, the metal target produces x-rays by creating holes in the inner core electron orbitals of the target atoms, which are then filled by electrons of the target with binding energies that are lower than the inner core electron orbitals, with concomitant generation of x-rays with energies that are characteristic of the target atoms. Most of the power of the electrons irradiating the target is converted into heat (e.g., about 60%) and backscattered electrons (e.g., about 39%), with only about 1% of the incident power converted into x-rays. Melting of the x-ray target due to this heat can be a limiting factor for the ultimate brightness (e.g., photons per second per area per steradian) achievable by the x-ray source.

Transmission-type x-ray sources configured to generate microfocus or nanofocus x-ray beams generally utilize targets comprising a thin sputtered metal layer (e.g., tungsten) over a thermally conductive, low density substrate material (e.g., diamond). The metal layer on one side of the target is irradiated by electrons, and the x-ray beam comprises x-rays emitted from the opposite side of the target. The x-ray spot size is dependent on the electron beam spot size, and in addition, due to electron bloom within the target, the x-rays generated and emitted from the target have an effective focal spot size that is larger than the focal spot size of the incident electron beam. As a result, transmission-type x-ray sources generating microfocus or nanofocus x-ray beams generally require very thin targets and very good electron beam focusing.

Conventional reflection-type x-ray sources irradiate a surface of a bulk target metal (e.g., tungsten) and collect the x-rays transmitted from the irradiated target surface at a take-off angle (e.g., 6-30 degrees) relative to the irradiated target surface, with the take-off angle selected to optimize the accumulation of x-rays while balancing with self-absorption of x-rays produced in the target. Because the electron beam spot at the target is effectively seen at an angle in reflection-type x-ray sources, the x-ray source spot size can be smaller than the electron beam spot size in transmission-type x-ray sources.

### SUMMARY

Certain embodiments described herein provide an x-ray target. The x-ray target comprises a thermally conductive substrate comprising a surface and at least one structure on or embedded in at least a portion of the surface. The at least one structure comprises a thermally conductive first material in thermal communication with the substrate. The first material has a length along a first direction parallel to the portion of the surface in a range greater than 1 millimeter and a width along a second direction parallel to the portion of the surface and perpendicular to the first direction. The width is in a range of 0.2 millimeter to 3 millimeters. The at least one structure further comprises at least one layer over the first material. The at least one layer comprises at least one second material different from the first material. The at least one layer has a thickness in a range of 2 microns to 50 microns. The at least one second material is configured to generate x-rays upon irradiation by electrons having energies in an energy range of 0.5 keV to 160 keV.

Certain embodiments described herein provide an x-ray source. The x-ray source comprises an x-ray target comprising a thermally conductive substrate comprising a surface and at least one structure on or embedded in at least a portion of the surface. The at least one structure comprises a thermally conductive first material in thermal communication with the substrate. The first material has a length along a first direction parallel to the portion of the surface in a range greater than 1 millimeter and a width along a second direction parallel to the portion of the surface and perpendicular to the first direction. The width is in a range of 0.2 millimeter to 3 millimeters. The at least one structure further comprises at least one layer over the first material. The at least one layer comprises at least one second material different from the first material. The at least one layer has a thickness in a range of 2 microns to 50 microns. The at least one second material is configured to generate x-rays upon irradiation by electrons having energies in an energy range of 0.5 keV to 160 keV. The x-ray source further comprises an electron source configured to generate electrons in at least one electron beam and to direct the at least one electron beam to impinge the at least one structure.

### BRIEF DESCRIPTION OF THE DRAWINGS

FIGS. 1A-1C schematically illustrate portions of example x-ray targets in accordance with certain embodiments described herein.

FIGS. 2A and 2B schematically illustrate portions of example x-ray targets having a plurality of structures separate from one another in accordance with certain embodiments described herein.

FIG. 3 schematically illustrates an example x-ray source of an example x-ray system in accordance with certain embodiments described herein.

FIGS. 4A and 4B schematically illustrate other examples of an x-ray source in accordance with certain embodiments described herein.

FIG. 5A schematically illustrates an example x-ray target in accordance with certain embodiments described herein, and FIGS. 5B-5I schematically illustrate various simulation results of the brightness from various versions of the example x-ray target of FIG. 5A.

### DETAILED DESCRIPTION

Certain embodiments described herein provide a reflection-type x-ray source which advantageously achieves small x-ray spot sizes while using electron beam spot sizes larger than those used in transmission-type x-ray sources (e.g., utilizing less rigorous electron beam focusing as compared to that used in transmission-type x-ray sources).

Certain embodiments described herein advantageously provide a reflection-type x-ray source with a high brightness of x-rays while avoiding the deleterious effects of excessive heating of the target. By using a cooled substrate and a high thermal conductivity first material (e.g., diamond) in thermal communication with the substrate and having a target layer of a second material deposited on the first material, heat can advantageously be removed from the target layer at a rate faster than would be achieved by removing the heat through bulk target material.

Certain embodiments described herein advantageously provide a reflection-type x-ray source with multiple target materials within a “sealed tube” source. By configuring the x-ray source to use an electron beam to irradiate a selected target material of the multiple target materials, with each target material generating x-rays having a corresponding x-ray spectrum with different characteristic x-ray energies, the reflection-type x-ray source can advantageously provide multiple, selectable x-ray spectra so that the x-ray source can be optimized for different applications, without having to open the x-ray source to change targets and to pump down the x-ray source each time.

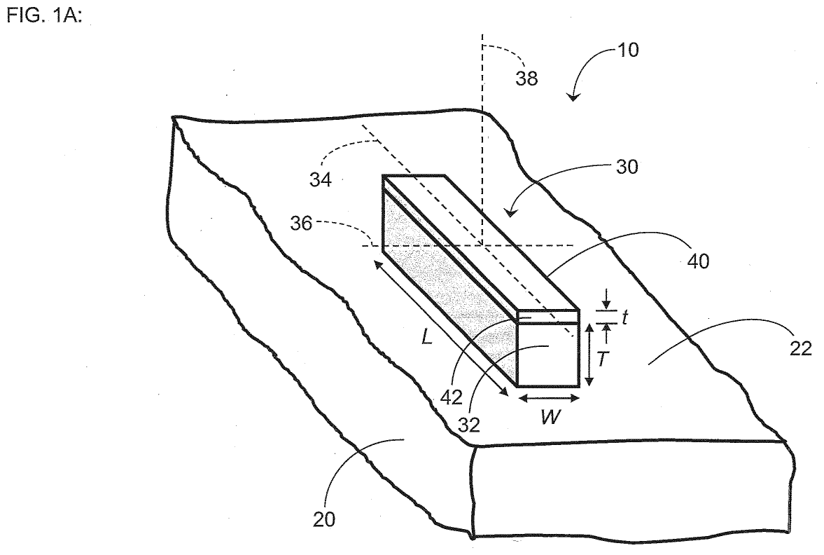

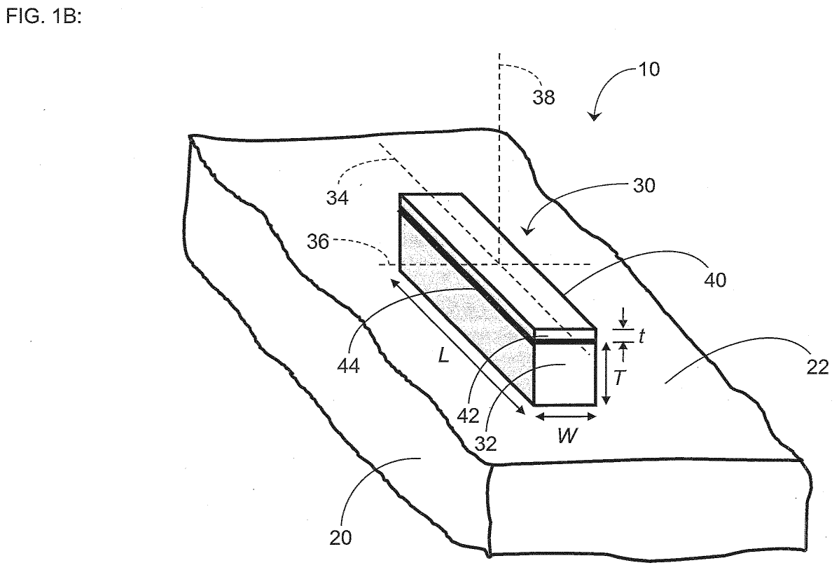

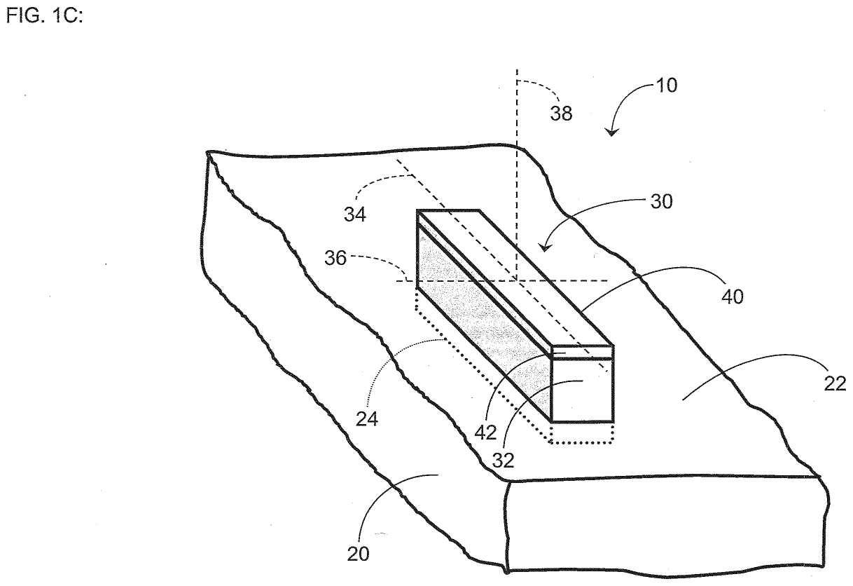

FIGS. 1A-1C schematically illustrate portions of example x-ray targets 10 in accordance with certain embodiments described herein. In each of FIGS. 1A-1C, the x-ray target 10 comprises a thermally conductive substrate 20 comprising a surface 22 and at least one structure 30 on or embedded in at least a portion of the surface 22. The at least one structure 30 comprises a thermally conductive first material 32 in thermal communication with the substrate 20. The first material 32 has a length L along a first direction 34 parallel to the portion of the surface 22, the length L in a range greater than 1 millimeter. The first material 32 also has a width W along a second direction 36 parallel to the portion of the surface 22 and perpendicular to the first direction 34, the width Win a range of 0.2 millimeter to 3 millimeters (e.g., 0.2 millimeter to 1 millimeter). The at least one structure 30 further comprises at least one layer 40 over the first material 32, the at least one layer 40 comprises at least one second material 42 different from the first material 32. The at least one layer 40 has a thickness T in a range of 1 micron to 50 microns (e.g., in a range of 1 micron to 20 microns; tungsten layer thickness in a range of 1 micron to 4 microns; copper layer thickness in a range of 2 microns to 7 microns), and the at least one second material 42 is configured to generate x-rays upon irradiation by electrons having energies in an energy range of 0.5 keV to 160 keV.

In certain embodiments, the target 10 is configured to transfer heat away from the at least one structure 30. For example, the surface 22 of the substrate 20 can comprise at least one thermally conductive material and the remaining portion of the substrate 20 can comprise the same at least one thermally conductive material and/or another one or more thermally conductive materials. Examples of the at least one thermally conductive material include but are not limited to, metals (e.g., copper; beryllium; doped graphite), metal alloys, metal composites, and electrically insulating but thermally conducting materials (e.g., diamond; graphite; diamond-like carbon; silicon; boron nitride; silicon carbide; sapphire). In certain embodiments, the at least one thermally conductive material has a thermal conductivity in a range between 20 W/m-K and 2500 W/m-K (e.g., between 150 W/m-K and 2500 W/m-K; between 200 W/m-K and 2500 W/m-K; between 2000 W/m-K and 2500 W/m-K) and comprises elements with atomic numbers less than or equal to 14. The surface 22 of the substrate 20 is electrically conductive in certain embodiments and is configured to be in electrical communication with an electrical potential (e.g., electrical ground) and is configured to prevent charging of the surface 22 due to electron irradiation of the target 10. In certain embodiments, the target 10 comprises a heat transfer structure in thermal communication with the substrate 20 and configured to transfer heat away from the target 10. Examples of heat transfer structures include but are not limited to, heat sinks, heat pipes, and fluid flow conduits configured to have a fluid coolant (e.g., liquid; water; deionized water; air; refrigerant; heat transfer fluid such as Galden® Perfluoropolyether fluorinated fluids marketed by Solvay S.A. of Brussels, Belgium) flow therethrough and to transfer heat away from the substrate 20 (e.g., at a rate similar to the power loading rate of the target 10 from the electron irradiation).

In certain embodiments, the thermally conductive first material 32 is configured to be adhered (e.g., joined; fixed; brazed; soldered) to the surface 22 of the substrate 20, such that the first material 32 is in thermal communication with the substrate 20. For example, the first material 32 can be soldered or brazed onto the surface 22 with a thermally conductive soldering or brazing material, examples of which include but are not limited to: CuSil-ABA® or Nioro® brazing alloys marketed by Morgan Advanced Materials of Windsor, Berkshire, United Kingdom; gold/copper braze alloys. As schematically illustrated in FIGS. 1A and 1B, in certain embodiments, the first material 32 is on the surface 22 and is adhered to the surface 22 by a soldering or brazing material (not shown) extending along at least a portion of the first material 32 and mechanically coupled to both the first material 32 and the surface 22. The soldering or brazing material can enhance (e.g., improve; facilitate) the thermal conductivity between the first material 32 and the surface 22. In certain other embodiments, the first material 32 is over the surface 22 with soldering or brazing material extending along at least a portion of the first material 32 and between the first material 32 and the surface 22, mechanically coupled to both the first material 32 and the surface 22, and enhancing (e.g., improving; facilitating) the thermal conductivity between the first material 32 and the surface 22. In certain embodiments, as schematically illustrated by FIG. 1C, the surface 22 comprises a recess 24 configured to have the first material 32 inserted partially into the recess 24 such that the structure 30 is embedded in at least a portion of the surface 22. The first material 32 can be adhered to the surface 22 by soldering or brazing material (not shown) extending along at least a portion of the first material 32, mechanically coupled to both the first material 32 and the surface 22, and enhancing (e.g., improving; facilitating) the thermal conductivity between the first material 32 and the surface 22.

Examples of the first material 32 include but are not limited to, at least one of: diamond, silicon carbide, beryllium, and sapphire. While FIG. 1A schematically illustrates the first material 32 having a half-cylinder, prism, or parallelepiped shape (e.g., ribbon; bar; strip; strut; finger; slab; plate) having substantially straight sides, any other shape (e.g., regular; irregular; geometric; non-geometric) with straight, curved, and/or irregular sides is also compatible with certain embodiments described herein. In certain embodiments, the length L of the first material 32 is the largest extent of the first material 32 in the first direction 34, and the width W of the first material 32 is the largest extent of the first material 32 in the second direction 36. The length L can be in a range greater than 1 millimeter, greater than 5 millimeters, 1 millimeter to 4 millimeters, 1 millimeter to 10 millimeters, or 1 millimeter to 20 millimeters. The width W can be in a range of 0.2 millimeter to 3 millimeters; 0.2 millimeter to 1 millimeter, 0.4 millimeter to 1 millimeter, 0.4 millimeter to 1 millimeter, 0.2 millimeter to 0.8 millimeter, or 0.2 millimeter to 0.6 millimeter. In certain embodiments, the thickness T of the first material 32 is the largest extent of the first material 32 in a direction perpendicular to the portion of the surface 22, and can be in a range of 0.2 millimeter to 1 millimeter, 0.4 millimeter to 1 millimeter, 0.4 millimeter to 1 millimeter, 0.2 millimeter to 0.8 millimeter, or 0.2 millimeter to 0.6 millimeter.

In certain embodiments, the at least one second material 42 of the at least one layer 40 is selected to generate x-rays having a predetermined energy spectrum (e.g., x-ray intensity distribution as function of x-ray energy) upon irradiation by electrons having energies in the energy range of 0.5 keV to 160 keV. Examples of the at least one second material 42 include but are not limited to, at least one of: tungsten, chromium, copper, aluminum, rhodium, molybdenum, gold, platinum, iridium, cobalt, tantalum, titanium, rhenium, silicon carbide, tantalum carbide, titanium carbide, boron carbide, and alloys or combinations including one or more thereof. In certain embodiments, the thickness t of the second material 42 is the largest extent of the second material 42 in the direction 38 perpendicular to the portion of the surface 22, and can be in a range of 2 microns to 50 microns, 2 microns to 20 microns, 2 microns to 15 microns, 4 microns to 15 microns, 2 microns to 10 microns, or 2 microns to 6 microns. In certain embodiments, the thickness t of the at least one second material 42 is substantially uniform across the whole area of the layer 40, while in certain other embodiments, the thickness t of the at least one second material 42 varies across the area of the layer 40 (e.g., a first end of the layer 40 has a first thickness of the at least one second material 42 and a second end of the layer 40 has a second thickness of the at least one second material 42, the second thickness larger than the first thickness).

In certain embodiments, the thickness t of the at least one second material 42 is selected as a function of the kinetic energy of the at least one electron beam irradiating the at least one structure 30. The electron penetration depth of electrons within a material is dependent on the material and the kinetic energy of the electrons, and in certain embodiments, the thickness t of the at least one second material 42 can be selected to be less than the electron penetration depth of the electrons in the at least one second material 42. For example, the continuous slowing down approximation (CSDA) can provide an estimate of the electron penetration depth for the electrons of a selected kinetic energy incident on the at least one second material 42, and the thickness t of the at least one second material 42 can be selected to be in a range of 50% to 70% of the CSDA estimate.

The at least one second material 42 in certain embodiments is configured to be in electrical communication with an electrical potential (e.g., electrical ground) and is configured to prevent charging of the at least one second material 42 due to electron irradiation. For example, electrically conductive soldering or brazing material (not shown in FIGS. 1A-1C) can be used to adhere (e.g., join; fix; braze; solder) the structure 30 to the surface 22, and at least some of this soldering or brazing material can extend from the surface 22 to the at least one second material 42 along at least a portion of one of the sides of the first material 32, thereby providing electrical conductivity between the at least one second material 42 and the surface 22.

In certain embodiments, as schematically illustrated by FIG. 1B, the at least one layer 40 further comprises at least one third material 44 between the first material 32 and the at least one second material 42, and the at least one third material 44 is different from the first material 32 and the at least one second material 42. Examples of the at least one third material 44 include but are not limited to, at least one of: titanium nitride (e.g., used with a first material 32 comprising diamond and a second material 42 comprising tungsten), iridium (e.g., used with a first material 32 comprising diamond and a second material 42 comprising molybdenum and/or tungsten), chromium (e.g., used with a first material 32 comprising diamond and a second material 42 comprising copper), beryllium (e.g., used with a first material 32 comprising diamond), and hafnium oxide. In certain embodiments, the thickness of the third material 44 is the largest extent of the second material 44 in the direction perpendicular to the portion of the surface 22, and can be in a range of 2 nanometers to 50 nanometers (e.g., 2 nanometers to 30 nanometers). In certain embodiments, the at least one third material 44 is selected to provide a diffusion barrier layer configured to avoid (e.g., prevent; reduce; inhibit) diffusion of the at least one second material 42 (e.g., tungsten) into the first material 32 (e.g., diamond). For example, a diffusion barrier layer can be graded from a carbide material at an interface with the diamond first material 32 to the at least one third material 44. In certain embodiments, the at least one third material 44 is configured to enhance (e.g., improve; facilitate) adhesion between the at least one second material 42 and the first material 32 and/or to enhance (e.g., improve; facilitate) thermal conductivity between the at least one second material 42 and the first material 32.

In certain embodiments, the length L and the width W of the first material 32 can be selected to be sufficiently small to avoid (e.g., prevent; reduce; inhibit) interfacial stress between the dissimilar first material 32 and the at least one second material 42, between the dissimilar first material 32 and the at least one third material 44, and/or between the dissimilar at least one second material 42 and the at least one third material 44. For example, each of the length L and the width W of the first material 32 can be less than 2 millimeters.

In certain embodiments, the first material 32 (e.g., diamond) can be cut (e.g., laser-cut) from a wafer or other structure (e.g., in strips). While FIGS. 1A-1C schematically illustrate certain embodiments in which the first material 32 has straight and smooth top, bottom, and side surfaces at perpendicular angles relative to one another, in certain other embodiments, the top, bottom, and/or side surfaces of the first material 32 are rough, irregular, or curved and/or are at non-perpendicular angles relative to one another. In certain embodiments, the at least one second material 42 and/or the at least one third material 44 can be deposited onto a top surface of the first material 32 (e.g., by a sputtering process such as magnetron sputtering). While FIGS. 1A-1C schematically illustrate certain embodiments in which the at least one second material 42 and the at least one third material 44 have straight and smooth top, bottom, and side surfaces and side surfaces which are flush with the sides of the first material 32, in certain other embodiments, the at least one second material 42 and/or the at least one third material 44 are rough, irregular, or curved surfaces, and/or the side surfaces extend beyond the top surface of the first material 32 (e.g., extending downward along the sides of the first material 32 below the top surface of the first material 32) and/or beyond one or more of the side surfaces of the first material 32 (e.g., extending outward in one or more directions parallel to the portion of the surface 22 such that the at least one second material 42 and/or the at least one third material 44 has a larger length and/or width than does the first material 32). While FIGS. 1A-1C schematically illustrate certain embodiments in which the top surface of the at least one second material 42 are parallel to the portion of the surface 22, in certain other embodiments, the top surface of the at least one second material 42 is non-parallel to the portion of the surface 22.

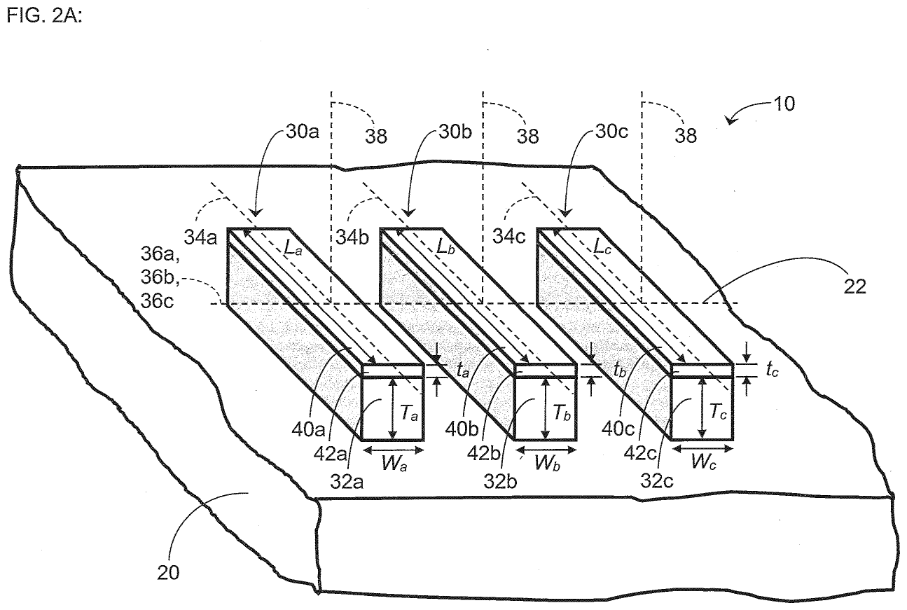

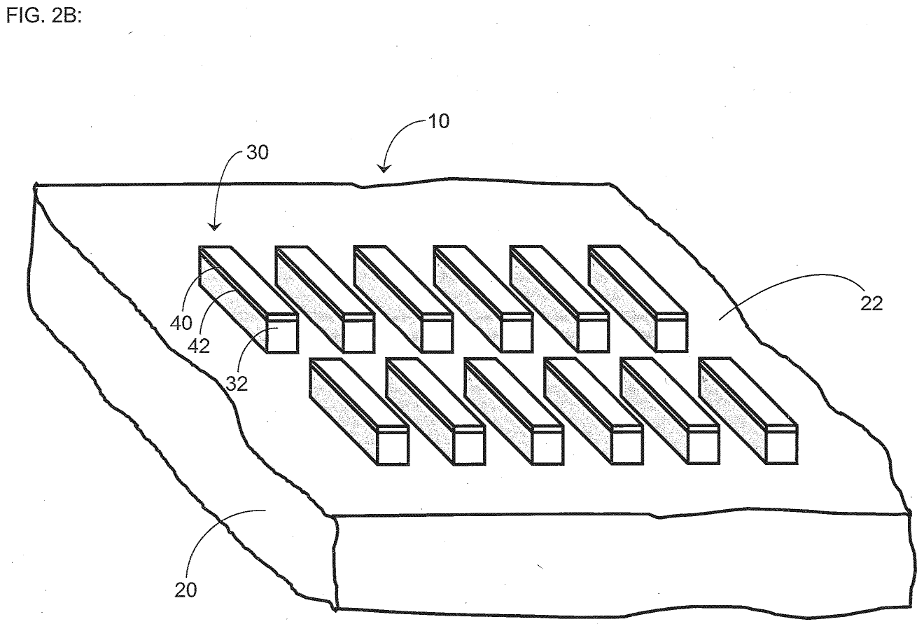

FIGS. 2A and 2B schematically illustrate portions of example x-ray targets 10 having a plurality of structures 30 separate from one another in accordance with certain embodiments described herein. In FIG. 2A, the target 10 comprises three structures 30a, 30b, 30c separated from one another and arranged in a linear configuration, each of which comprises a corresponding first material 32a, 32b, 32c, at least one corresponding layer 40a, 40b, 40c over the corresponding first material 32a, 32b, 32c and comprising at least one corresponding second material 42a, 42b, 42c different from the corresponding first material 32a, 32b, 32c. In FIG. 2B, the target 10 comprises twelve structures 30 separated from one another and arranged in a rectilinear array configuration, each of which comprises a corresponding first material 32, at least one corresponding layer 40 over the corresponding first material 32 and comprising at least one corresponding second material 42 different from the corresponding first material 32. Other numbers of structures 30 (e.g., 2, 4, 5, 6, 7, 8, 9, 10, 11, or more) are also compatible with certain embodiments described herein.

In certain embodiments, the first materials 32 of two or more of the structures 30 can be the same as one another (e.g., all the first materials 32 the same as one another), the first materials 32 of two or more of the structures 30 can be different from one another, the second materials 42 of two or more of the structures 30 can be the same as one another, and/or the second materials 42 of two or more of the structures 30 can be different from one another (e.g., all the second materials 42 different from one another). The x-rays generated by at least two of the structures 30 can have spectra (e.g., intensity distributions as functions of x-ray energy) that are different from one another (e.g., all the spectra from the different structures 30 can be different from one another). In certain embodiments, some or all of the structures 30 can comprise at least one third material 44 between the first material 32 and the second material 42, and the third materials 44 of two or more of the structures 30 can be the same as one another and/or the third materials 44 of two or more of the structures 30 can be different from one another.

In certain embodiments, each of the structures 30 has a corresponding long dimension (e.g., length Lₐ, L_{b}, L_{c}) along a first direction 34a, 34b, 34c parallel to the portion of the surface 22 and a corresponding short dimension (e.g., width Wₐ, W_{b}, W_{c}) along a second direction 36a, 36b, 36c perpendicular to the first direction 34a, 34b, 34c and parallel to the portion of the surface 22. The long dimensions of two or more of the structures 30 can be equal to one another (e.g., all the long dimensions equal to one another), the long dimensions of two or more of the structures 30 can be non-equal to one another, the short dimensions of two or more of the structures 30 can be equal to one another (e.g., all the short dimensions equal to one another), and/or the short dimensions of two or more of the structures can be non-equal to one another. In certain embodiments, each of the layers 40 has a corresponding thickness (e.g., tₐ, t_{b}, t_{c}) in a direction 38 perpendicular to the portion of the surface 22. The thicknesses of two or more of the structures 30 can be equal to one another (e.g., all the thicknesses equal to one another) and/or the thicknesses of two or more of the structures 30 can be non-equal to one another (e.g., all the thicknesses non-equal to one another). Adjacent structures 30 of certain embodiments are spaced from one another by separation distances in a direction parallel to the portion of the surface 22, and the separation distances are in a range greater than 0.02 millimeter, 0.02 millimeter to 4 millimeters, 0.2 millimeter to 4 millimeters, 0.4 millimeter to 2 millimeters, 0.4 millimeter to 1 millimeter, or 1 millimeter to 4 millimeters. The separation distance between a first two adjacent structures 30 and the separation distance between a second two adjacent structures 30 can be equal to one another or non-equal to one another.

As schematically illustrated in FIG. 2A, the example structures 30 are arranged in a linear configuration, with the structures 30 aligned with one another (e.g., having their long dimensions along first directions 34a, 34b, 34c that are parallel to one another and their short dimensions along second directions 36a, 36b, 36c parallel to and/or coincident with one another). In certain other embodiments, the structures 30 are not aligned with one another (e.g., having their long dimensions along first directions 34a, 34b, 34c that are non-parallel to one another and/or their short dimensions along second directions 36a, 36b, 36c non-parallel to and/or non-coincident with one another). As schematically illustrated in FIG. 2B, the example structures 30 are arranged in a rectilinear array configuration, with a first set of structures 30 aligned with one another (e.g., having their long dimensions along first directions 34 that are parallel to one another and their short dimensions along second directions 36 parallel and/or coincident with one another) and a second set of structures 30 aligned with one another and with the first set of structures 30 (e.g., having their long dimensions along first directions 34 parallel to and/or coincident with the long dimensions of the first set of structures 30). In certain other embodiments, the structures 30 of the array are not aligned with one another (e.g., non-parallel to and/or non-coincident long dimensions and/or short dimensions). Various other arrangements of the arrays of structures 30 are also compatible with certain embodiments described herein (e.g., non-rectilinear; non-aligned; non-equal separation distances; etc.). For example, a first set of the structures 30 can have a first periodicity and a second set of the structures 30 can have a second periodicity different from the first periodicity (e.g., different in one or two directions parallel to the portion of the surface 22). For another example, one or both of the first set and the second set can be non-periodic (e.g., in one or two directions parallel to the portion of the surface 22).

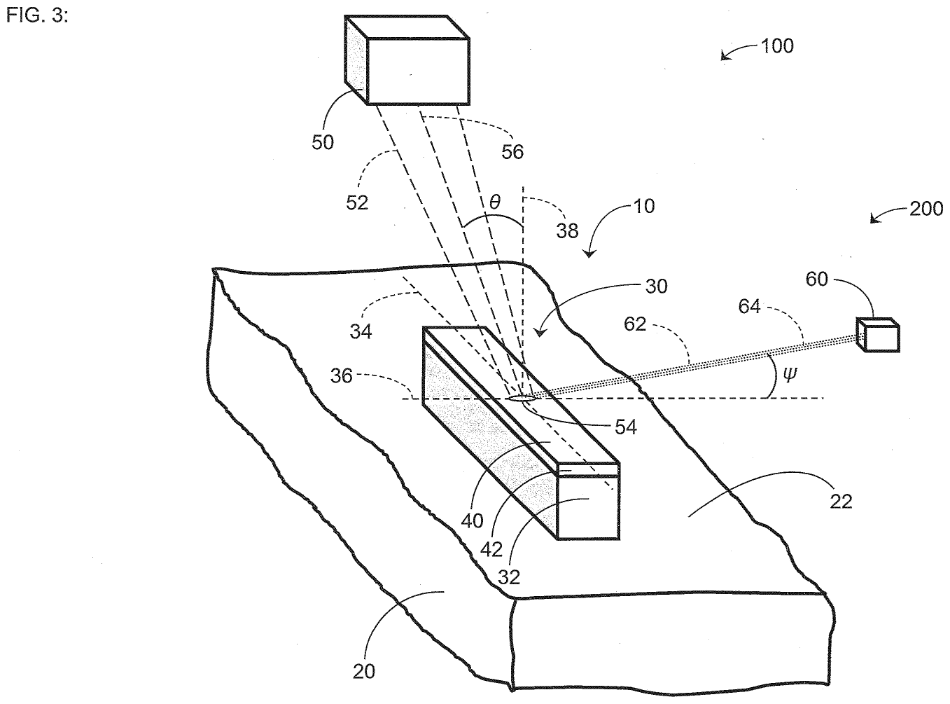

FIG. 3 schematically illustrates an example x-ray source 100 of an example x-ray system 200 in accordance with certain embodiments described herein. The x-ray source 100 comprises an x-ray target 10 as described herein and an electron source 50 configured to generate electrons in at least one electron beam 52 and to direct the at least one electron beam 52 to impinge the at least one structure 30 of the x-ray target 10 in an electron beam spot 54 having a spot size. The electron source 50 can comprise an electron emitter having a dispenser cathode (e.g., comprising tungsten or lanthanum hexaboride) configured to emit electrons (e.g., via thermionic or field emission) to be directed to impinge the at least one structure 30. The dispenser cathode of certain embodiments has an aspect ratio equal to an aspect ratio of the electron beam spot 54 impinging the at least one structure 30. Example dispenser cathodes in accordance with certain embodiments described herein are marketed by Spectra-Mat, Inc. of Watsonville, Calif. (e.g., thermionic emitters comprising a porous tungsten matrix impregnated with barium aluminate).

The electron source 50 further comprises electron optics components (e.g., deflection electrodes; grids; etc.) configured to receive the electrons emitted from the electron emitter, to accelerate the electrons to a predetermined electron kinetic energy (e.g., in a range of 0.5 keV to 160 keV), to form (e.g., shape and/or focus) the at least one electron beam 52, and to direct the at least one electron beam 52 onto the target 10. Example configurations of electron optics components in accordance with certain embodiments described herein include but are not limited to, two-grid configurations and three-grid configurations. In certain embodiments, the x-ray target 10 is configured to be used as an anode (e.g., set at a positive voltage relative to the electron source 50) to accelerate and/or otherwise modify the electron beam 52.

In certain embodiments, the kinetic energy of the at least one electron beam 52 is selected such that the electron penetration depth of the electrons of the at least one electron beam 52 within the at least one second material 42 is greater than the thickness t of the at least one second material 42. For example, the kinetic energy of the at least one electron beam 52 can be selected to correspond to a CSDA estimate of the electron penetration depth that is greater than the thickness t of the at least one second material 42 (e.g., a CSDA estimate of the electron penetration depth that is in a range of 1.5× to 2× of the thickness t of the at least one second material 42).

In certain embodiments, the electron source 50 is positioned relative to the x-ray source 10 such that a center of the at least one electron beam 52 impinges the at least one structure 30 at a non-zero angle θ (e.g., impact angle) relative to the direction 38 perpendicular to the portion of the surface 22 or to the at least one layer 40 of the structure 30 greater than 20 degrees (e.g., in a range of 20 degrees to 50 degrees; in a range of 30 degrees to 60 degrees; in a range of 40 degrees to 70 degrees). The center line 56 of the at least one electron beam 52 can be in a plane defined by the direction 38 and the first direction 34, in a plane defined by the direction 38 and the second direction 36, or in another plane substantially perpendicular to the portion of the surface 22. The at least one electron beam 52 can have a rectangular-type beam profile, an oval-type beam profile, or another type of beam profile.

In certain embodiments, as schematically illustrated in FIG. 3, the at least one electron beam 52 is focused onto the at least one layer 40 of the at least one structure 30 such that the electron beam spot 54 has a full-width-at-half maximum spot size (e.g., width of the region of the electron beam spot 54 at which the at least one electron beam 52 has an intensity of at least one-half of the maximum intensity of the at least one electron beam 52) on the at least one structure 30 that is smaller than the smallest dimension of the layer 40 in a direction parallel to the portion of the surface 22. For example, the full-width-at-half maximum spot size of the electron beam spot 54 on the at least one structure 30 can have a maximum width in a direction parallel to the portion of the surface 22 of 100 microns or less, 75 microns or less, 50 microns or less, 30 microns or less, or 15 microns or less. In certain embodiments, the full-width-at-half maximum spot size has a first dimension in a direction parallel to the portion of the surface 22 (e.g., in the first direction 34) in a range of 5 microns to 20 microns and a second dimension in another direction (e.g., in the second direction 36) perpendicular to the direction and parallel to the portion of the surface 22 in a range of 20 microns to 200 microns (e.g., the second dimension is in a range of 4× to 10× of the first dimension; the electron beam spot 54 having an aspect ratio in a range of 4:1 to 10:1).

In certain embodiments, an x-ray system 200 comprises the x-ray source 100 as described herein and at least one x-ray optic 60 configured to receive x-rays 62 from the x-ray source 100 propagating along a propagation direction having a take-off angle ψ (e.g., angle of a center line 64 of an acceptance cone of the at least one x-ray optic 60, the angle defined relative to a direction parallel to the portion of the surface 22) in a range of 0 degrees to 40 degrees (e.g., in a range of 0 degrees to 3 degrees; in a range of 2 degrees to 5 degrees; in a range of 4 degrees to 6 degrees; in a range of 5 degrees to 10 degrees). For example, the at least one x-ray optic 60 can be configured to receive x-rays 62 emitted from the x-ray source 100 (e.g., through a window substantially transparent to the x-rays 62) and the take-off angle ψ can be in a plane perpendicular to the plane defined by the center line 56 of the electron beam 52 and the direction 38. In certain embodiments, the take-off angle ψ is selected such that the electron beam spot 54, when viewed along the center line 64 at the take-off angle ψ, is foreshortened (e.g., to appear to be substantially symmetric; to appear to have an aspect ratio of 1:1). For example, the focal spot from which x-rays 62 are collected by the at least one x-ray optic 60 can have a full-width-at-half maximum focal spot size (e.g., width of the region of the focal spot at which the x-rays 62 have an intensity of at least one-half of the maximum intensity of the x-rays 62) that is less than 20 microns, less than 15 microns, or less than 10 microns.

Various configurations of the at least one x-ray optic 60 and the x-ray system 200 are compatible with certain embodiments described herein. For example, the at least one x-ray optic 60 can comprise at least one of a polycapillary-type or single capillary-type optic, with an inner reflecting surface having a shape of one or more portions of a quadric function (e.g., portion of an ellipsoid and/or portions of mirrored paraboloids facing one another). The x-ray system 200 can comprise multiple x-ray optics 60, each optimized for efficiency for a specific x-ray energy of interest, and can be configured to selectively receive x-rays 62 from the x-ray target 10 (e.g., each x-ray optic 60 paired with a corresponding structure 30 of the x-ray target 10). Various example x-ray optics 60 and x-ray systems 200 with which the x-ray source 100 disclosed herein can be used in accordance with certain embodiments described herein are disclosed in U.S. Pat. Nos. 9,570,265, 9,823,203, 10,295,486, and 10,295,485, each of which is incorporated in its entirety by reference herein.

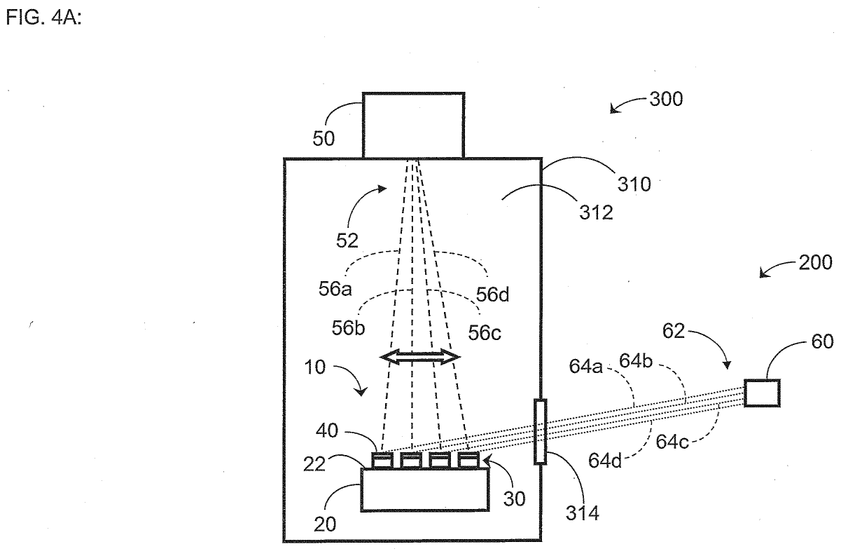

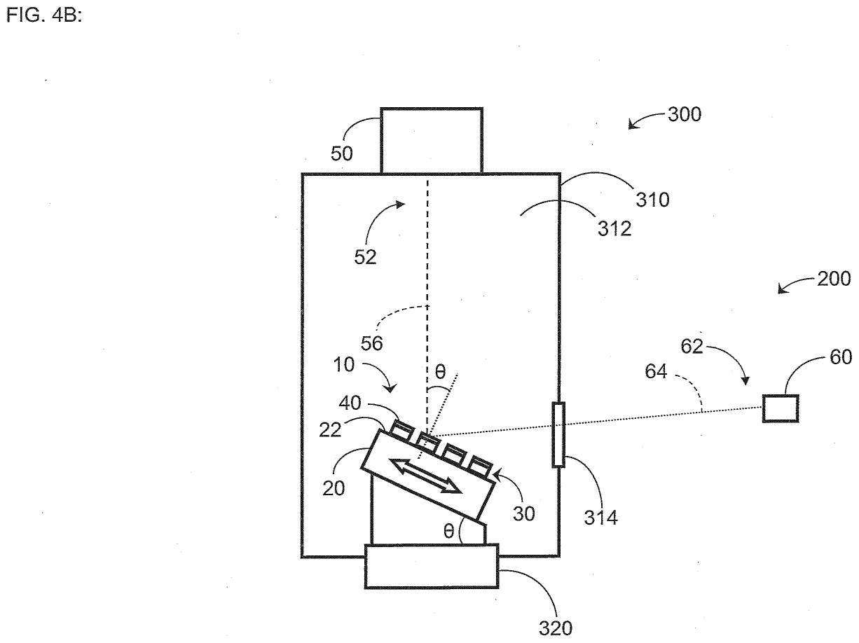

FIGS. 4A and 4B schematically illustrate other examples of an x-ray source 300 in accordance with certain embodiments described herein. The x-ray source 300 comprises an x-ray target 10 comprising a thermally conductive substrate 20 comprising a surface 22 and at least one structure 30 on or embedded in at least a portion of the surface 22 of the substrate 20 (see, e.g., FIGS. 1A-1C and 2A-2B). The x-ray source 300 further comprises an electron source 50 (see, e.g., FIG. 3) and a housing 310 containing a region 312 under vacuum (e.g., having a gas pressure less than 1 Torr) and sealed from the atmosphere surrounding the housing 310. The region 312 contains the at least one structure 30 and the at least one electron beam 52 from the electron source 50 is configured to propagate through a portion of the region 312 and impinge a selected one of the at least one structure 30.

In certain embodiments, the at least one structure 30 comprises a plurality of structures 30 separate from one another (see, e.g., FIGS. 2A-2B) and at least one of the target 10 and the at least one electron beam 52 is configured to be controllably moved to impinge a selected one of the plurality of structures 30 with the at least one electron beam 52 while the plurality of structures 30 remain in the sealed region 312. As described herein with regard to FIGS. 2A-2B, the second materials 42 of two or more of the structures 30 can be different from one another (e.g., all the second materials 42 different from one another) such that the x-rays generated by at least two of the structures 30 can have spectra that are different from one another (e.g., all the spectra can be different from one another), thereby advantageously providing an ability to select among different x-ray spectra. In addition, as described herein with regard to FIGS. 2A-2B, the second materials 42 of two or more of the structures 30 can be the same as one another, thereby advantageously providing a redundancy (e.g., in the event that one of the structures 30 is damaged or degraded, another one of the structures 30 can be used instead). While FIGS. 4A and 4B schematically illustrate the structures 30 oriented with their long dimensions along the first directions 34a, 34b, 34c perpendicular to the direction towards the at least one x-ray optic 60, one or more (e.g., all) of the structures 30 can alternatively have any other orientation relative to the direction towards the at least one x-ray optic 60 (e.g., in a plane defined by the direction towards the at least one x-ray optic 60 and the direction of trajectory of the at least one electron beam 52). The at least one electron beam 52 can impinge the structures 30 in a direction perpendicular to the surface 22 or to the at least one layer 40 of the structure 30 (e.g., an impact angle of 0 degrees), as schematically illustrated in FIG. 4A, or in a direction at a non-zero impact angle θ (e.g., in a range of 10 degrees to 80 degrees; in a range of 10 degrees to 30 degrees; in a range of 20 degrees to 40 degrees; in a range of 30 degrees to 50 degrees; in a range of 40 degrees to 60 degrees; in a range of 50 degrees to 70 degrees; in a range of 60 degrees to 80 degrees; in a range greater than 70 degrees) relative to a direction perpendicular to the surface 22 or to the at least one layer 40 of the structure 30.

As schematically illustrated in FIG. 4A, the electron source 50 is configured to selectively direct (e.g., deflect) the at least one electron beam 52 along a selected trajectory to impinge a selected one of the plurality of structures 30 (e.g., utilizing electron optics components, such as deflection electrodes). As shown in FIG. 4A, the x-ray target 10 can be oriented such that the at least one electron beam 52 impinges the structures 30 in a direction perpendicular to the surface 22 or to the at least one layer 40 of the structure 30. In FIG. 4A, the movement of the at least one electron beam 52 is schematically indicated by the double-headed arrow and each of the trajectories of the at least one electron beam 52 corresponding to the at least one electron beam 52 impinging a selected one of the plurality of structures 30 is schematically indicated by a corresponding center line 56a, 56b, 56c, 56d of the at least one electron beam 52. The x-rays 62 emitted from the irradiated structure 30 and transmitted through an x-ray transparent window 314 of the housing 310 are collected by the at least one x-ray optic 60. In FIG. 4A, each of the trajectories of the collected x-rays 62 corresponding to the at least one electron beam 52 impinging a selected one of the plurality of structures 30 is schematically indicated by a corresponding center line 64a, 64b, 64c, 64d of the x-rays 62. In certain embodiments, the position and/or orientation of the at least one x-ray optic 60 can be adjusted to account for the focal spot of the x-rays 62 being at different positions.

As schematically illustrated in FIG. 4B, the x-ray source 300 further comprises a stage 320 configured to move the x-ray target 10 relative to the electron source 50 such that a selected one of the plurality of structures 30 is impinged by the at least one electron beam 52. As shown in FIG. 4B, the x-ray target 10 can be oriented such that the at least one electron beam 52 impinges the structures 30 at a non-zero impact angle θ relative to a direction perpendicular to the surface 22 or to the at least one layer 40 of the structure 30. In FIG. 4B, a translation of the target 10 by the stage 320 along a direction parallel to the surface 22 of the substrate 20 is schematically indicated by the double-headed arrow. The stage 320 of certain embodiments can translate the structures 30 in one direction, in two directions (e.g., perpendicular to one another), in three directions (e.g., three directions perpendicular to one another), and/or can rotate the x-ray target 10 about one or more axes of rotation (e.g., two or more axes perpendicular to one another). In certain embodiments, one or more of the directions of translation of the target 10 by the stage 320 can be in a direction perpendicular to the at least one electron beam 42. In certain embodiments, the stage 320 comprises components (e.g., actuators; sensors) that are within the region 312 other components (e.g., computer controller; feedthroughs; motor) that are at least partially outside the region 312. The stage 320 has a sufficient amount of movement to place each of the structures 30 in position to be impinged by the at least one electron beam 52.

The x-rays 62 emitted from the irradiated structure 30 and transmitted through an x-ray transparent window 314 of the housing 310 are collected by the at least one x-ray optic 60. In certain embodiments, the position of the source of the x-rays 62 remains unchanged when selecting among the different structures 30, thereby advantageously avoiding adjustments of the position and/or orientation of the at least one x-ray optic 60 to account for different positions of the x-ray focal spot. In certain embodiments, a combination of the selectively directed electron beam 52 and the selectively movable stage 320 can be used.

While conventional sealed-tube x-ray sources typically provide focal spot sizes of about 1 millimeter and low brightness, certain embodiments described herein can provide an x-ray source that has a much smaller focal spot size and much higher brightness. Certain embodiments described herein utilize at least one electron beam 52 focused and incident onto the structure 30 with a spot size (e.g., full-width-at-half-maximum diameter) in a range of 0.5 μm to 100 μm (e.g., 2 μm; 5 μm; 10 μm; 20 μm; 50 μm), a total power in a range of 5 W to 1 kW (e.g., 10 W; 30-80 W; 100 W; 200 W), and a power density in a range of 0.2 W/μm² to 100 W/μm² (e.g., 0.3-0.8 W/μm²; 2.5 W/μm²; 8 W/μm²; 40 W/μm²) and the x-ray brightness (e.g., proportional to the electron beam power density) is in a range of 0.5×10¹⁰ photons/mm²/mrad² to 5×10¹² photons/mm²/mrad² (e.g., 1-3×10¹⁰ photons/mm² photons/mm²; 1×10¹¹ photons/mm²/mrad²; 3×10¹¹ photons/mm²/mrad²; 2×10¹² photons/mm²/mrad²).

In addition, by having multiple structures 30 that are selectively impinged by the at least one electron beam 52, certain embodiments described herein can provide such small focal spot sizes and higher brightnesses with the flexibility to select an x-ray spectrum from a plurality of x-ray spectra by computer-controlled movement of the at least one electron beam 52 and/or the x-ray target 10 while remaining under vacuum (e.g., without having to break vacuum, replace one x-ray target with another, and pump down to return to vacuum conditions). By moving the x-ray target 10 with 1 micron or sub-micron accuracy, certain embodiments advantageously avoid re-alignment of the at least one x-ray optic 60 and/or other components of the x-ray system 200.

By providing multiple selectable x-ray spectra, certain embodiments described herein can advantageously be used in various types of x-ray instrumentation that utilize a microfocus x-ray spot, including but not limited to: x-ray microscopy, x-ray fluorescence (XRF), x-ray diffraction (XRD), x-ray tomography; x-ray scattering (e.g., SAXS; WAXS); x-ray absorption spectroscopy (e.g., XANES; EXAFS), and x-ray emission spectroscopy.

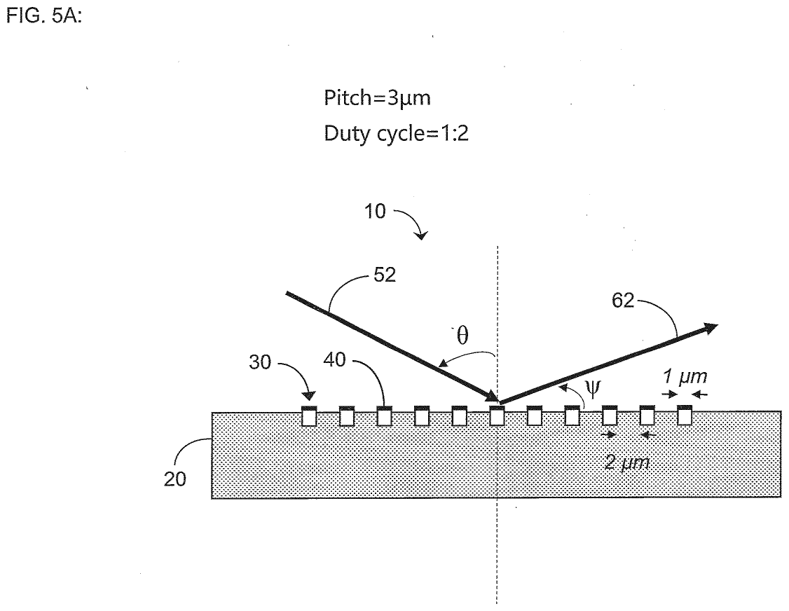

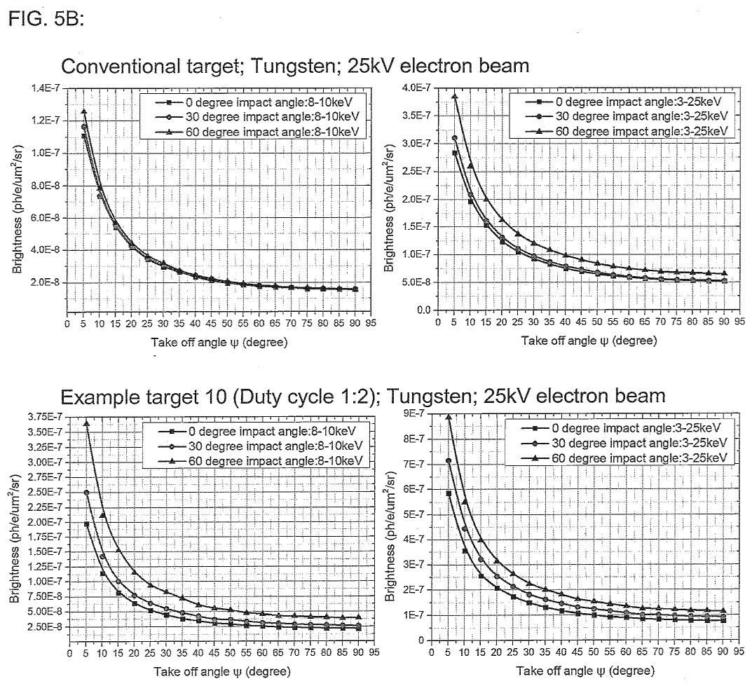

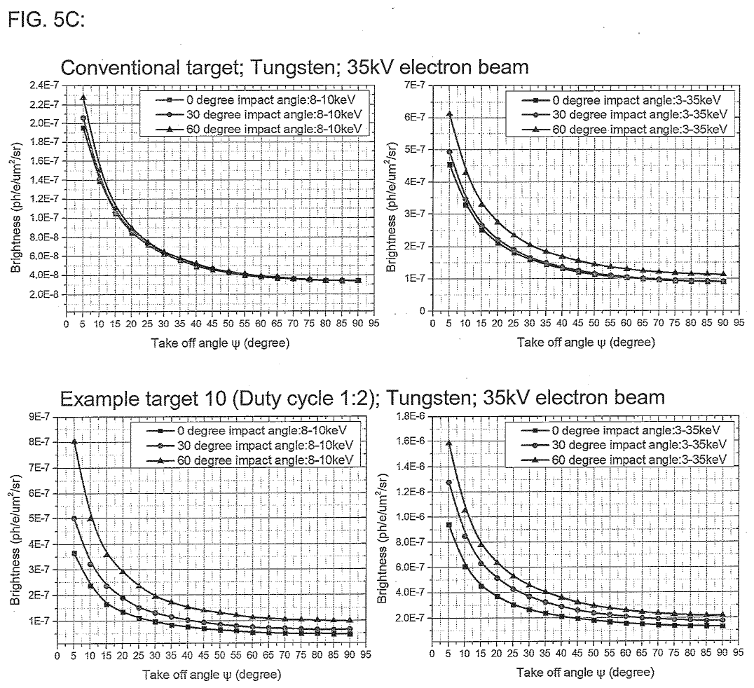

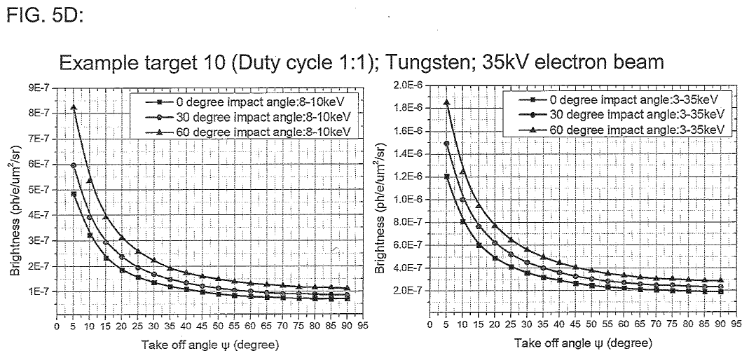

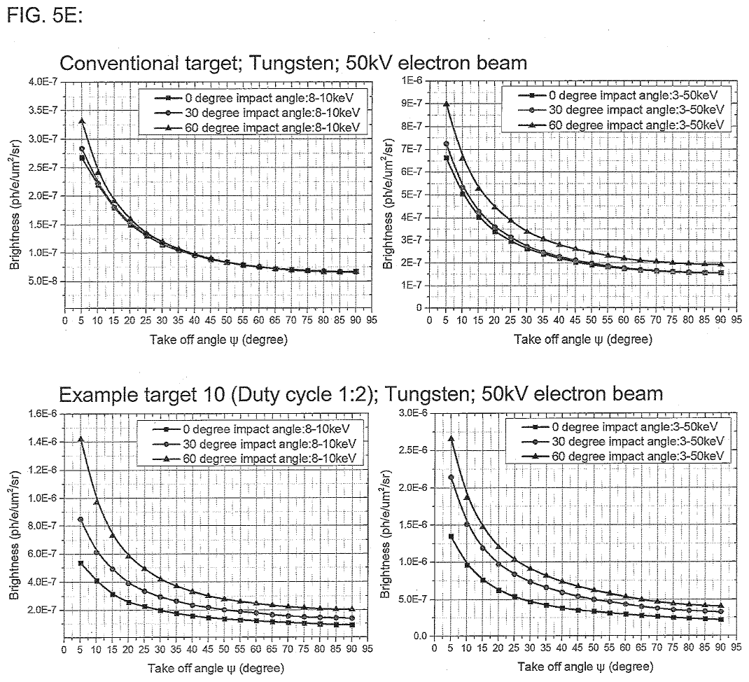

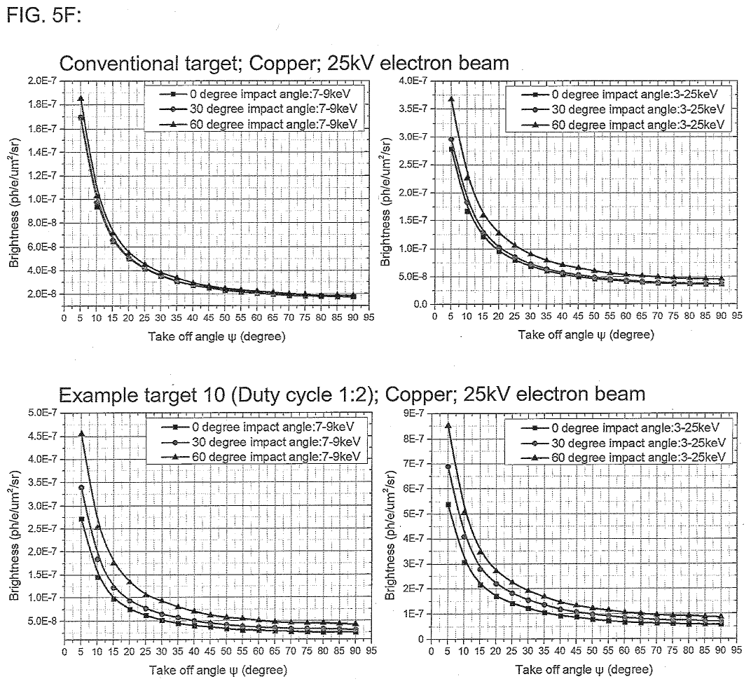

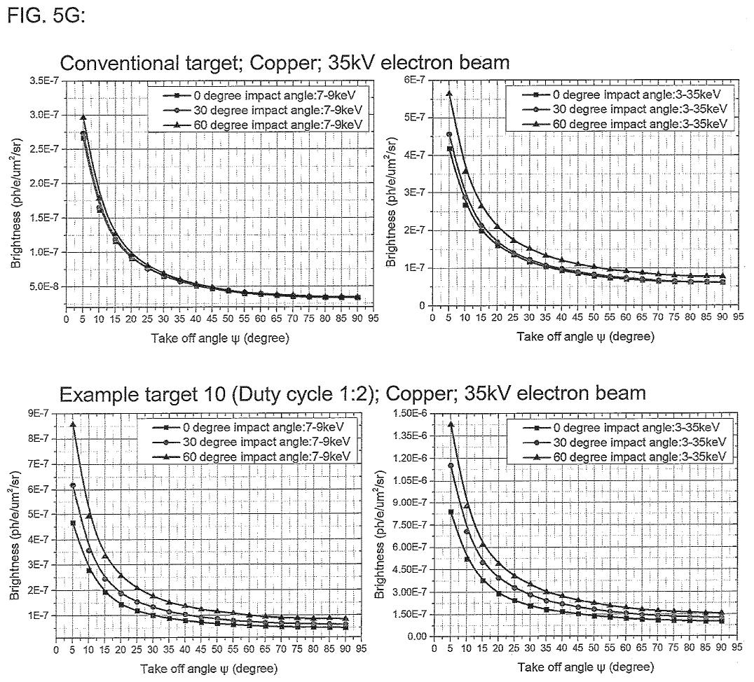

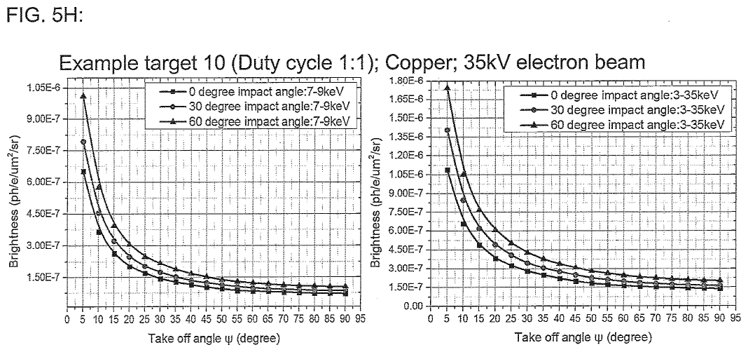

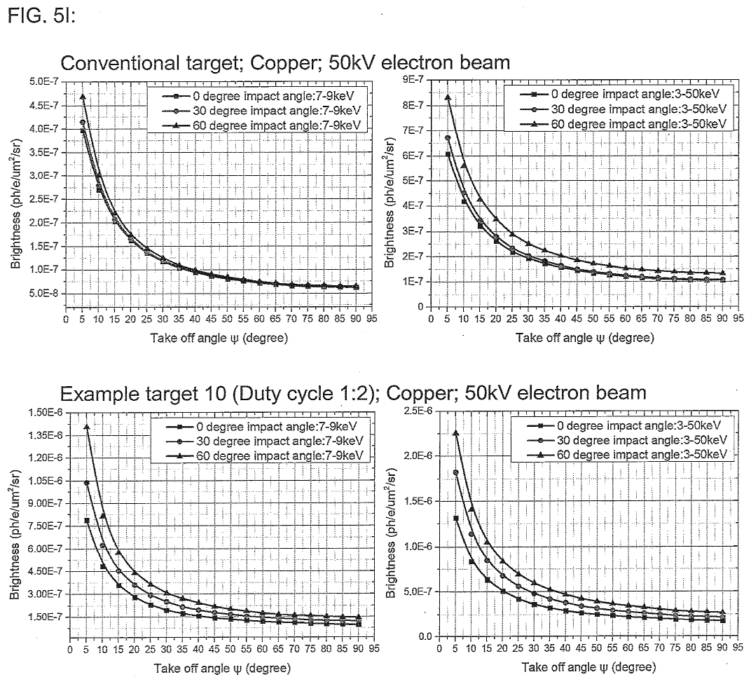

FIG. 5A schematically illustrates an example x-ray target 10 with discrete structures 30 in accordance with certain embodiments described herein, and FIGS. 5B-5I schematically illustrate various simulation results of the brightness from various versions of the example x-ray target 10 of FIG. 5A in accordance with certain embodiments described herein. Each structure 30 has a metal layer 40 (e.g., tungsten; copper) on a first material 32 of diamond at least partially embedded in a copper substrate 20. FIGS. 5B-5I compare these simulation results of the brightness with those corresponding to an example conventional x-ray target having a continuous thin metal film (e.g., tungsten; copper) deposited onto a continuous diamond layer on a copper substrate. The brightness in FIGS. 5B-5I is defined as the number of photons emitted per unit area and unit solid angle per incident electron (e.g., photons/electron/μm²/steradian).

For the simulations of FIGS. 5B, 5C, 5E, 5F, 5G, and 5I, each structure 30 has a width of 1 μm and the structures 30 are spaced from one another (e.g., between adjacent edges) by 2 μm (e.g., having a pitch of 3 μm and a duty cycle of 1:2), as shown in FIG. 5A. For the simulations of FIGS. 5D and 5H, each structure 30 has a width of 1 μm and the structures 30 are spaced from one another (e.g., between adjacent edges) by 1 μm (e.g., having a pitch of 2 μm and a duty cycle of 1:1). According to thermal modeling calculations, the x-ray target 10 of FIG. 5A can withstand an electron power density that is four times higher than on a solid copper anode for the same maximum temperature (e.g., 65 W versus 12.5 W). In the simulation results of FIGS. 5B-5I, to account for the larger fraction of scatter electrons at higher impact angles, the power of the electron beam 52 at an impact angle of 60 degrees was increased by 1.3 times as compared to an impact angle of 0 degrees.

FIG. 5B compares the brightness of x-rays as a function of take-off angle and for three impact angles (0, 30, and 60 degrees) generated by a 25 kV electron beam and emitted from (i) a conventional tungsten target and (ii) an example target 10 with structures 30 with a tungsten layer 40 in accordance with certain embodiments described herein with a duty cycle of 1:2. On the left side of FIG. 5B, the brightness for x-rays having energies of 8-10 keV is shown and on the right side of FIG. 5B, the brightness for x-rays having energies of 3-25 keV is shown.

FIG. 5C compares the brightness of x-rays as a function of take-off angle and for three impact angles (0, 30, and 60 degrees) generated by a 35 kV electron beam and emitted from (i) a conventional tungsten target and (ii) an example target 10 with structures 30 with a tungsten layer 40 in accordance with certain embodiments described herein with a duty cycle of 1:2. On the left side of FIG. 5C, the brightness for x-rays having energies of 8-10 keV is shown and on the right side of FIG. 5C, the brightness for x-rays having energies of 3-35 keV is shown.

FIG. 5D shows the brightness of x-rays as a function of take-off angle and for three impact angles (0, 30, and 60 degrees) generated by a 35 kV electron beam and emitted from an example target 10 with structures 30 with a tungsten layer 40 in accordance with certain embodiments described herein with a duty cycle of 1:1. On the left side of FIG. 5D, the brightness for x-rays having energies of 8-10 keV is shown and on the right side of FIG. 5C, the brightness for x-rays having energies of 3-35 keV is shown.

FIG. 5E compares the brightness of x-rays as a function of take-off angle and for three impact angles (0, 30, and 60 degrees) generated by a 50 kV electron beam and emitted from (i) a conventional tungsten target and (ii) an example target 10 with structures 30 with a tungsten layer 40 in accordance with certain embodiments described herein with a duty cycle of 1:2. On the left side of FIG. 5E, the brightness for x-rays having energies of 8-10 keV is shown and on the right side of FIG. 5E, the brightness for x-rays having energies of 3-50 keV is shown.

FIG. 5F compares the brightness of x-rays as a function of take-off angle and for three impact angles (0, 30, and 60 degrees) generated by a 25 kV electron beam and emitted from (i) a conventional copper target and (ii) an example target 10 with structures 30 with a copper layer 40 in accordance with certain embodiments described herein with a duty cycle of 1:2. On the left side of FIG. 5F, the brightness for x-rays having energies of 7-9 keV is shown and on the right side of FIG. 5E, the brightness for x-rays having energies of 3-25 keV is shown.

FIG. 5G compares the brightness of x-rays as a function of take-off angle and for three impact angles (0, 30, and 60 degrees) generated by a 35 kV electron beam and emitted from (i) a conventional copper target and (ii) an example target 10 with structures 30 with a copper layer 40 in accordance with certain embodiments described herein with a duty cycle of 1:2. On the left side of FIG. 5G, the brightness for x-rays having energies of 7-9 keV is shown and on the right side of FIG. 5G, the brightness for x-rays having energies of 3-35 keV is shown.

FIG. 5H compares the brightness of x-rays as a function of take-off angle and for three impact angles (0, 30, and 60 degrees) generated by a 35 kV electron beam and emitted from an example target 10 with structures 30 with a copper layer 40 in accordance with certain embodiments described herein with a duty cycle of 1:1. On the left side of FIG. 5H, the brightness for x-rays having energies of 7-9 keV is shown and on the right side of FIG. 5H, the brightness for x-rays having energies of 3-35 keV is shown.

FIG. 5I compares the brightness of x-rays as a function of take-off angle and for three impact angles (0, 30, and 60 degrees) generated by a 50 kV electron beam and emitted from (i) a conventional copper target and (ii) an example target 10 with structures 30 with a copper layer 40 in accordance with certain embodiments described herein with a duty cycle of 1:2. On the left side of FIG. 5I, the brightness for x-rays having energies of 7-9 keV is shown and on the right side of FIG. 5I, the brightness for x-rays having energies of 3-50 keV is shown.

As shown by these simulation results, the example targets 10 in accordance with certain embodiments described herein exhibit higher brightnesses than do conventional targets. For a tungsten layer with an impact angle of 60 degrees and a take-off angle of 5 degrees and for the three electron beam energies (25 kV, 35 kV, 50 kV), Table 1A shows the brightnesses (photons/electron/m²/steradian) of x-rays having energies 8-10 keV and Table 1B shows the brightnesses photons/electron/m²/steradian) of x-rays having energies greater than 3 keV. These results were made assuming that the example target 10 exhibits four times the heat dissipation than the conventional target and with a correction of 1.3 times to account for higher electron scattering at the incident angle of 60 degrees as compared to 0 degrees.

TABLE 1A

| Electron | Brightness from | Brightness from | Brightness |
|---|---|---|---|
| Energy | Conventional target | Example target 10 | Ratio |
| 25 kV | 1.26E−07 | 3.64E−07 | 2.90 |
| 35 kV | 2.28E−07 | 8.02E−07 | 3.52 |
| 50 kV | 3.32E−07 | 1.42E−06 | 4.27 |

TABLE 1B

| Electron | Brightness from | Brightness from | Brightness |
|---|---|---|---|
| Energy | Conventional target | Example target 10 | Ratio |
| 25 kV | 3.85E−07 | 8.86E−07 | 2.30 |
| 35 kV | 6.12E−07 | 1.58E−06 | 2.59 |
| 50 kV | 8.98E−07 | 2.66E−06 | 2.96 |

For a copper layer with an impact angle of 60 degrees and a take-off angle of 5 degrees and for the three electron beam energies (25 kV, 35 kV, 50 kV), Table 2A shows the brightnesses (photons/electron/m²/steradian) of x-rays having energies 7-9 keV and Table 2B shows the brightnesses photons/electron/m²/steradian) of x-rays having energies greater than 3 keV. These results were made assuming that the example target 10 exhibits four times the heat dissipation than the conventional target and with a correction of 1.3 times to account for higher electron scattering at the incident angle of 60 degrees as compared to 0 degrees.

TABLE 2A

| Electron | Brightness from | Brightness from | Brightness |
|---|---|---|---|
| Energy | Conventional target | Example target 10 | Ratio |
| 25 kV | 1.85E−07 | 4.55E−07 | 2.46 |
| 35 kV | 2.96E−07 | 8.56E−07 | 2.89 |
| 50 kV | 4.69E−07 | 1.41E−06 | 3.00 |

TABLE 2B

| Electron | Brightness from | Brightness from | Brightness |
|---|---|---|---|
| Energy | Conventional target | Example target 10 | Ratio |
| 25 kV | 3.67E−07 | 8.52E−07 | 2.32 |
| 35 kV | 5.64E−07 | 1.43E−06 | 2.53 |
| 50 kV | 8.32E−07 | 2.26E−06 | 2.71 |

Various configurations have been described above. Although this invention has been described with reference to these specific configurations, the descriptions are intended to be illustrative of the invention and are not intended to be limiting. Various modifications and applications may occur to those skilled in the art without departing from the true spirit and scope of the invention. Thus, for example, in any method or process disclosed herein, the acts or operations making up the method/process may be performed in any suitable sequence and are not necessarily limited to any particular disclosed sequence. Features or elements from various embodiments and examples discussed above may be combined with one another to produce alternative configurations compatible with embodiments disclosed herein. Various aspects and advantages of the embodiments have been described where appropriate. It is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein.

1. An x-ray target comprising:
a thermally conductive substrate comprising a surface; and
a plurality of structures separate from one another and on or embedded in at least a portion of the surface, each of at least two structures of the plurality of structures comprising:
a thermally conductive first material in thermal communication with the substrate; and
at least one layer over the first material, the at least one layer comprising at least one second material different from the first material, the at least one second material configured to generate x-rays upon irradiation by electrons.

2. The x-ray target of claim 1, wherein the first material of each of the at least two structures extends along a direction parallel to the portion of the surface by a distance in a range of 0.2 millimeter to 3 millimeters.

3. The x-ray target of claim 1, wherein the first material of each of the at least two structures extends along a direction parallel to the portion of the surface by a distance in a range of 1 millimeter to 20 millimeters.

4. The x-ray target of claim 1, wherein separations of adjacent structures of the plurality of structures are in a range of 1 millimeter to 4 millimeters.

5. The x-ray target of claim 1, wherein a separation along a direction parallel to the surface between adjacent edges of a first two adjacent structures of the plurality of structures is non-equal to a separation along the direction parallel to the surface between adjacent edges of a second two adjacent structures of the plurality of structures.

6. The x-ray target of claim 1, wherein the first material comprises diamond and/or silicon carbide.

7. The x-ray target of claim 1, wherein the at least one layer has a thickness in a range of 1 micron to 20 microns.

8. The x-ray target of claim 1, wherein the first materials of the at least two structures are the same as one another and the at least one second materials of the at least two structures are different from one another.

9. The x-ray target of claim 1, wherein a first structure of the at least two structures is configured to generate x-rays having a first energy spectrum and a second structure of the at least two structures is configured to generate x-rays having a second energy spectrum, the second energy spectrum different from the first energy spectrum.

10. The x-ray target of claim 1, wherein the at least one second material comprises at least one of: tungsten, chromium, copper, aluminum, rhodium, molybdenum, gold, platinum, iridium, cobalt, tantalum, titanium, rhenium, silicon carbide, tantalum carbide, titanium carbide, boron carbide, and alloys or combinations including one or more thereof.

11. An x-ray source comprising:
an x-ray target comprising:
a thermally conductive substrate comprising a surface; and
a plurality of structures separate from one another and on or embedded in at least a portion of the surface, each of at least two structures of the plurality of structures comprising:
a thermally conductive first material in thermal communication with the substrate; and
at least one layer over the first material, the at least one layer comprising at least one second material different from the first material; and
an electron source configured to generate electrons in at least one electron beam and to direct the at least one electron beam to impinge the at least one structure.

12. The x-ray source of claim 11, wherein a largest extent of the first material of each of the at least two structures along a direction parallel to the portion of the surface is in a range of 0.2 millimeter to 3 millimeters and/or in a range of 1 millimeter to 20 millimeters.

13. The x-ray source of claim 11, wherein the at least one second material has a thickness less than an electron penetration depth of the electrons in the at least one second material.

14. The x-ray source of claim 11, wherein the at least one electron beam has an electron beam spot on the plurality of structures, the electron beam spot having a first dimension in a first direction parallel to the portion of the surface in a range of 5 microns to 20 microns and a second dimension in a second direction parallel to the portion of the surface and perpendicular to the first direction in a range of 20 microns to 200 microns.

15. The x-ray source of claim 11, wherein the at least one electron beam has an electron beam spot on the plurality of structures, the electron beam spot having an aspect ratio in a range of 4:1 to 10:1.

16. The x-ray source of claim 11, wherein the at least one electron beam impinges the plurality of structures such that a center line of the at least one electron beam is at a non-zero angle relative to a direction perpendicular to the portion of the surface.

17. The x-ray source of claim 11, wherein at least one of the x-ray target and the at least one electron beam is configured to be controllably moved such that the at least one electron beam impinges a selected one of the plurality of structures.

18. A method comprising:
impinging a first selected structure of a plurality of structures with at least one electron beam, the plurality of structures separate from one another and on or embedded in at least a portion of a surface of a thermally conductive substrate, each of at least two structures of the plurality of structures comprising:
a thermally conductive first material in thermal communication with the substrate; and
at least one layer over the first material, the at least one layer comprising at least one second material different from the first material, the at least one second material configured to generate x-rays in response to being impinged by the at least one electron beam; and
controllably moving the substrate and/or the at least one electron beam relative to one another; and
impinging a second selected structure of the plurality of structures with the at least one electron beam.

19. The method of claim 18, wherein the x-rays generated in response to said impinging the first selected structure have a first energy spectrum and the x-rays generated in response to said impinging the second selected structure have a second energy spectrum that is different from the first energy spectrum.

20. The method of claim 18, wherein the plurality of structures are within a sealed region and said controllably moving the at least one of the substrate and the at least one electron beam occurs while the plurality of structures remain within the sealed region.

21. The method of claim 18, wherein said controllably moving the substrate and/or the at least one electron beam relative to one another comprises moving the substrate along a direction parallel to the surface.
